(19) United States
(12) Patent Application Publication
(10) Pub. No.: US 2017/0317333 A1
(43) Pub. Date: Nov. 2, 2017

(54) Multiple Voltage Output Battery Case with Protection and Alarm System

(71) Applicants: Arthur F. Seymour, Deerfield, IL (US); Alexander R. Matz, Wheeling, IL (US)

(72) Inventors: Arthur F. Seymour, Deerfield, IL (US); Alexander R. Matz, Wheeling, IL (US)

(21) Appl. No.: 15/499,707

(22) Filed: Apr. 27, 2017

Related U.S. Application Data
(60) Provisional application No. 62/328,692, filed on Apr. 28, 2016.

(51) Int. Cl. H01M 2/34; H01M 2/10; H01M 10/42; H01M 10/48; H01M 2/20

(52) U.S. Cl. CPC H01M 2/348; H01M 10/486; H01M 2/202; H01M 2/1016; H01M 10/425; H01M 2010/4271; H01M 2200/103

(57) ABSTRACT

A battery holder containing 2 or more batteries connected to allow multiple voltage outputs. Each output being protected by an automatically resettable circuit to limit maximum current under all possible external connections and sound an alarm or produce a visual indication or both if any output current is exceeded. Protection and alarm are designed to sense current levels and work in holders with weak batteries, alkaline cells, mercury cells, lithium cells, rechargeable cells, and any cell with voltage greater than 1 volt. Protection and alarm will also work when battery holder has some batteries not installed. Protection circuits are not part of the batteries and remain with the battery holder when batteries are changed.

### CROSS-REFERENCE TO RELATED APPLICATIONS

The following application is based on and claims the priority benefit of U.S. provisional application Ser. No.: 62/328,692 filed Apr. 28, 2016 currently co-pending; the entire contents of which are incorporated by reference.

### BACKGROUND OF THE INVENTION

A multiple-voltage output battery case with protection and alarm systems is provided. The present system relates generally to battery cases which hold batteries connected in a manner which allows more than one output voltage. The present system insures that the batteries will be protected from excessive current draw and further provides indication if the current is exceeded. The indication of excessive current may be audible, visual, or both. The present system may also allow for protection and warnings if some of the batteries are removed.

Voltage output protection and alarm systems of batteries have been invented in the past. For example, U.S. Pat. No. 4,255,698 to Simon discloses methods of battery charge and/or discharge control which makes use of an electrical device which is connected in series with the cell or cells of the battery and which is preferably a permanent part of the battery, so that when the battery terminals are connected in order to charge or discharge the battery, the device provides an automatic guard against excessive battery temperatures and/or current discharges. The device comprises a PTC element which is preferably composed of a conductive polymer composition, and which is in a low resistance state under normal operating conditions but which changes to a high resistance state (and thus reduces the charging current or the discharge current) when the temperature and/or current become excessive.

Further, U.S. Pat. No. 8,237,409 to Jang discloses a protective circuit module of a secondary battery and a secondary battery using the same, the protection circuit module including a positive temperature coefficient (PTC) device and a circuit board, wherein terminals of the PTC device are inserted into the circuit board to be coupled with connection terminals of the circuit board so that workability is improved and manufacturing costs are reduced. The secondary battery sensitively reacts to a temperature increase of the secondary battery by installing the PTC device on the upper or lower side of the circuit board, or extending one terminal of the PTC device to a bare cell of the secondary battery.

There are many devices and products that are powered by batteries. Many battery cells may have voltage levels from 0.8 volts when weak and over 3 volts when new. In some cases, the battery holder may be used in different circuits for educational purposes, in toys, small appliances, in industry, or in laboratories doing research to name just a few. A switch may allow the user to change the voltage but does not allow all the voltages to be available to the user simultaneously. If a connection allows too much current to flow from a battery, it may become extremely hot and the battery may even explode. The most popular voltages used today are 3, 6, 9, and 12 volts.

If each output of the battery holder is simply fused it would be cumbersome and expensive when correcting blown fuses since there could be many possible fuses. Mechanically resettable fuses are expensive and some can be overridden by holding the reset button. They also often require the added action of finding the open fuse and resetting it. These problems are resolved by using fusing circuits which limit the maximum current, indicates the troubling area, and automatically resets when normal conditions are restored. The present system may be as complicated as an integrated circuit or as simple as a positive temperature coefficient (PTC) resettable fuse which triggers an electronic beeper. Each battery with an output may require a fuse and indicator to insure full protection. One such solution is to place a PTC fuse circuit in series with each output that will limit all currents from that output to a safe level. As the current at the output increases the temperature of the PTC increases, lowers the output current and triggers an indicator for that output failure.

This reduction in current lowers the voltage out and prevents damage to both external components and the internally installed battery. As soon as the electrical current is restored to a safe level the fusing circuit will reset, restoring the output to the proper voltage. When any fusing circuit is activated it would be desirable to produce a visual and/or audible output to the user.

### BRIEF DESCRIPTION OF FIGURES AND TABLES

FIG. 1 Illustrates an exploded view of all the components that are required to build a battery holder 127 that activates an audible tone device 110 if excess current occurs.

FIG. 2 Illustrates an assembled view of the battery holder 127.

FIG. 3 Illustrates an electronic schematic drawing of circuit board 135 used in FIG. 1.

FIG. 4 Illustrates a connection of battery holders 127 to produce higher voltages.

FIG. 5 Illustrates a 3 volt per cell battery holder 527 with LED indicators 501-504 with no audible tone indicator.

FIG. 6 Illustrates an electronic schematic drawing for a 3 volt per cell battery holder 527 with LED indicators 501-504 shown in FIG. 5.

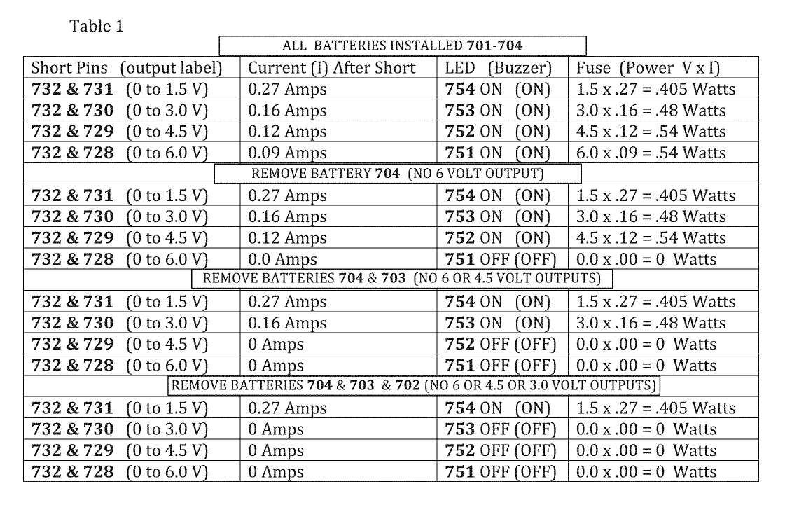

FIG. 7 Illustrates an electronic schematic of a battery holder 527 that uses an extra battery 713 to provide enough voltage to activate both sound 712 and visual indicators 751-754 when output current is exceeded. FIG. 7 also shows how the addition of diodes 705-708 can make the battery holder 527 produce an audible warning even if some batteries are missing or not installed.

Table 1 Illustrates typical data for a battery holder 527 with electronic circuit 700 using 1.5 volt alkaline cells 701-704, 713 with 1 to 4 batteries installed.

Table 2 Illustrates voltages required to activate different colored LEDs.

### DETAILED DESCRIPTION OF THE PREFERRED EMBODIMENT

A multiple-voltage output battery case with protection and alarm systems is provided. The present system relates generally to battery cases which hold batteries connected in a manner which allows more than one output voltage. The present system insures that the batteries will be protected from excessive current draw and further provides indication if the current is exceeded. The indication of excessive current may be audible, visual, or both. The present system may also allow for protection and warnings if some of the batteries are removed.

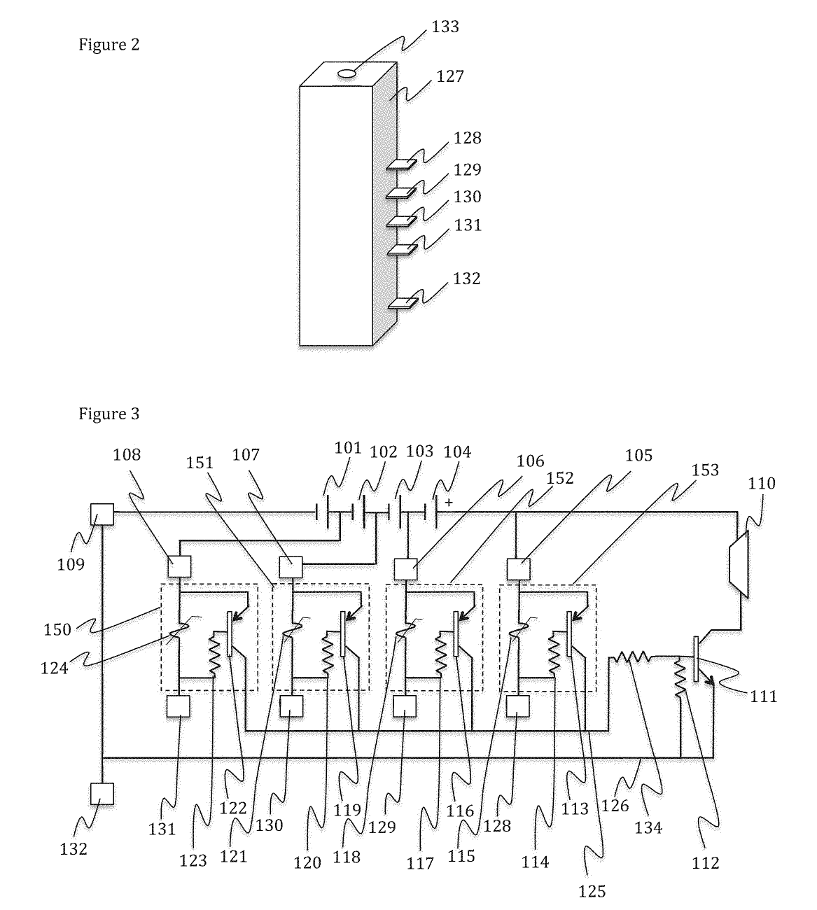

The present system utilizes, for example, an improved battery holder 127 with multiple voltage outputs 128-132, Positive Temperature Coefficient (PTC) fuses 115, 118, 121, 124, an audible alarm 110, a printed circuit board 135 containing electronic components 111-124 and common copper paths 125,126. In an embodiment, the fuses 115 are automatically resettable. Although the battery holder 127 and voltage outputs 128-132 may be physically designed for general use, the battery holder 127 and voltage outputs 128-132 may be modified in an embodiment for a specific purpose without changing the uniqueness or function of the present system. In the assembled battery holder 127 shown in FIG. 2, a hole 133 may be provided in the battery holder 127 to allow sound from audio device 110 (such as a speaker) to enter surroundings at greater intensity and warn the user of an over current condition.

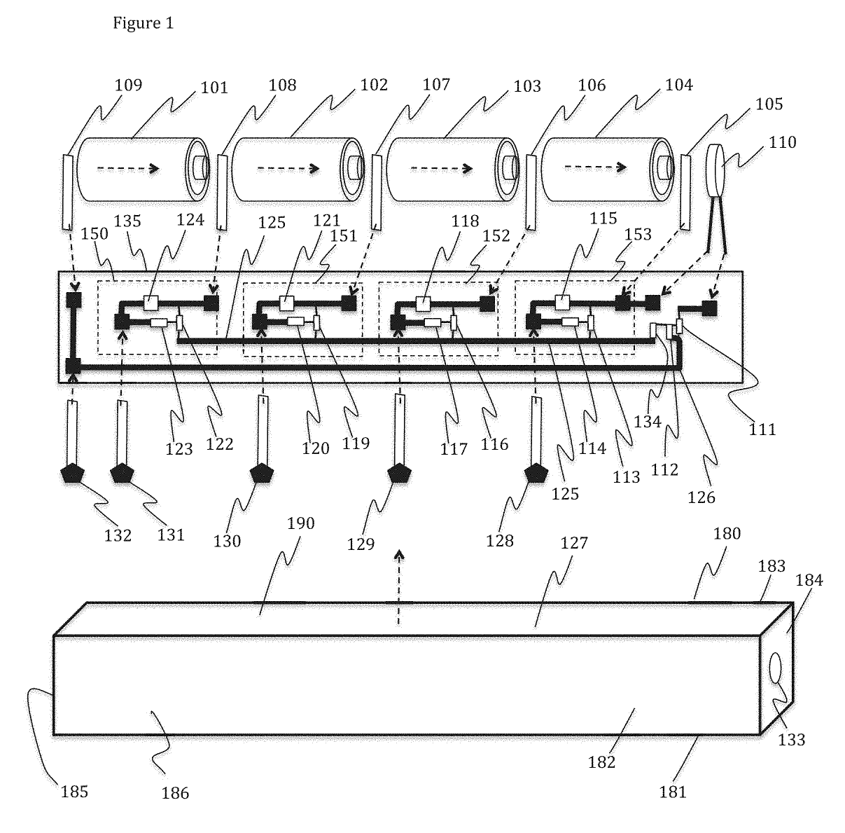

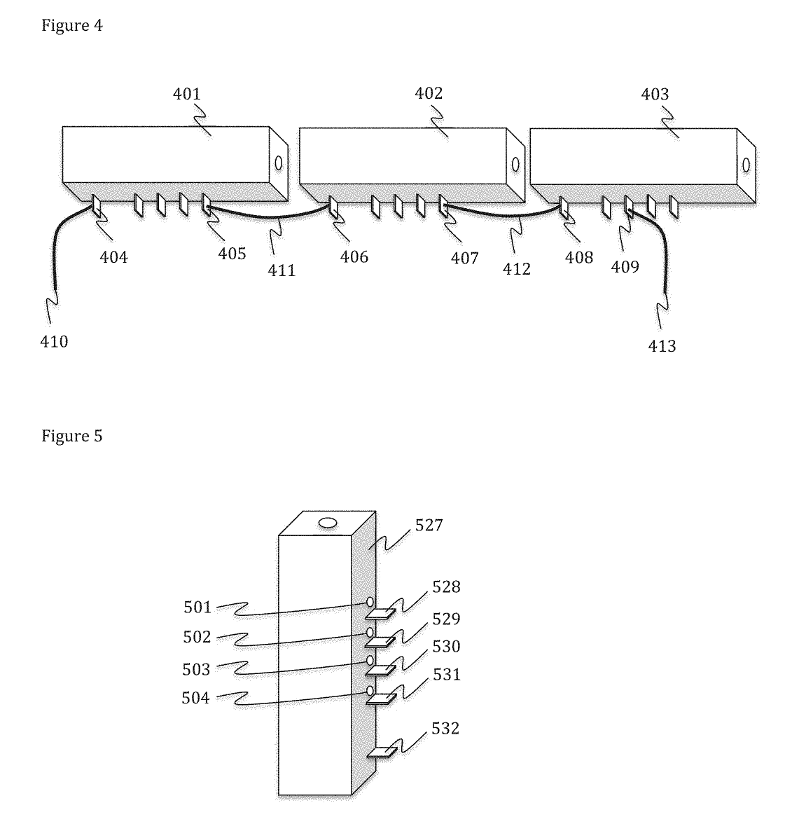

Referring now to FIG. 1 and FIG. 3, protection fusing circuits 150-153 for each battery 101-104 respectively are illustrated. FIG. 1 shows the surface mount printed circuit board 135 layout while FIG. 3 illustrates the electronic schematic for the components 111-124 on the surface mount printed circuit board 135. Identical numbers are given for both the physical component and its electronic symbol for clarity. The protection fusing circuits 150-153 are located in a battery housing 127 (illustrated by the rectangular box at the bottom of FIG. 1). The battery housing 127 may have a top 180, a bottom 181, a front 184, a back 185, a first side 182, a second side 183 and a hollow interior 186 wherein the protection fusing circuits 150-153 and other elements (including the batteries) are located. An opening 190 may be present at the top 180 of the battery housing 127 so as to allow the temporary insertion and removal of the batteries 101-104. The device is especially suitable for use with electronic devices such as, for example, toys and teaching equipment.

The negative end of battery 101 may be connected to a surface mount printed circuit board 135 by conductive battery tab 109. The conductive battery tab 109 may also connected to a zero volt or ground run 126 on the surface mount printed circuit board 135. The zero volt output tab 132 may also be connected to the zero volt or ground run 126 on the surface mount printed circuit board 135. The positive end of battery 101 may be connected to the surface mount printed circuit board 135 by conductive battery tab 108. Outlined section 150 illustrates that one end of a PTC fuse 124 may be connected to conductive battery tab 108 and the other end of the PTC fuse 124 may be connected to conductive output tab 131. As a result, this places the protective PTC fuse 124 in series with the positive voltage of the first battery 101 and the output tab 131 for that voltage. Any current drawn from output tab 131 which exceeds a predetermined trigger threshold for PTC fuse 124 will increase the resistance of PTC fuse 124, dropping the voltage present at output tab 131 and limiting the current from battery 101 to a safe value. Also shown in outlined fusible circuit section 150 is the emitter of a PNP transistor 122 is connected to the battery tab 108 and the base of the PNP transistor 122 is connected to one end of a resistor 123. The other end of resistor 123 may be connected to the conductive output tab 131. As a result, this may place the emitter-base of PNP transistor 122 and resistor 123 series combination in parallel with the PTC fuse 124. During normal currents through PTC fuse 124 the voltage drop across PTC fuse 124 will be too low to turn on PNP transistor 122. When the voltage drop across PTC fuse 124 rises to lower the output current at output tab 131 the PNP transistor 122 will switch on and current will flow from the collector of the PNP transistor 122 through the resistors 134 and 112 to the zero volt or ground run 126 on the surface mount printed circuit board 135.

The other three protection fusible circuits 151-153 may perform substantially similar to protection circuit 150 for batteries 102-104 respectively. The only difference may be that the negative end of battery 102 may be connected to the positive end of battery 101 and battery tab 108. The positive end of battery 102 may be connected to the surface mount printed circuit board 135 by conductive battery tab 107. Circuit section 151 performs substantially identical to circuit section 150 with output tab 130 being protected by PTC fuse 121 and voltage at output tab 130 being raised by two battery levels above zero volt or ground tab 132. The negative end of battery 103 may be connected to the positive end of battery 102 and battery tab 107. The positive end of battery 103 may be connected to the surface mount printed circuit board 135 by conductive battery tab 106.

Fusible circuit section 152 may perform substantially similar to fusible circuit section 151 with output tab 129 being protected by PTC fuse 118 and voltage at output tab 129 being raised by one battery level above output tab 130 and three battery levels above zero volt or ground tab 132. The negative end of battery 104 may be connected to the positive end of battery 103 and battery tab 106. The positive end of battery 104 may be connected to the surface mount printed circuit board 135 by conductive battery tab 105. Fusible circuit section 153 may perform substantially similar to circuit section 152 with output tab 128 being protected by PTC fuse 115 and voltage at output tab 128 being raised by one battery level above output tab 129 and four battery levels above zero volt or ground tab 132. Since the collectors of all of the PNP transistors 122, 119, 116, 113 are tied together current will flow from the collector of the PNP transistor 122, 119, 116, 113 through the current path 125 and through resistors 134 and 112 to the zero volt or ground run 126 on the surface mount printed circuit board 135.

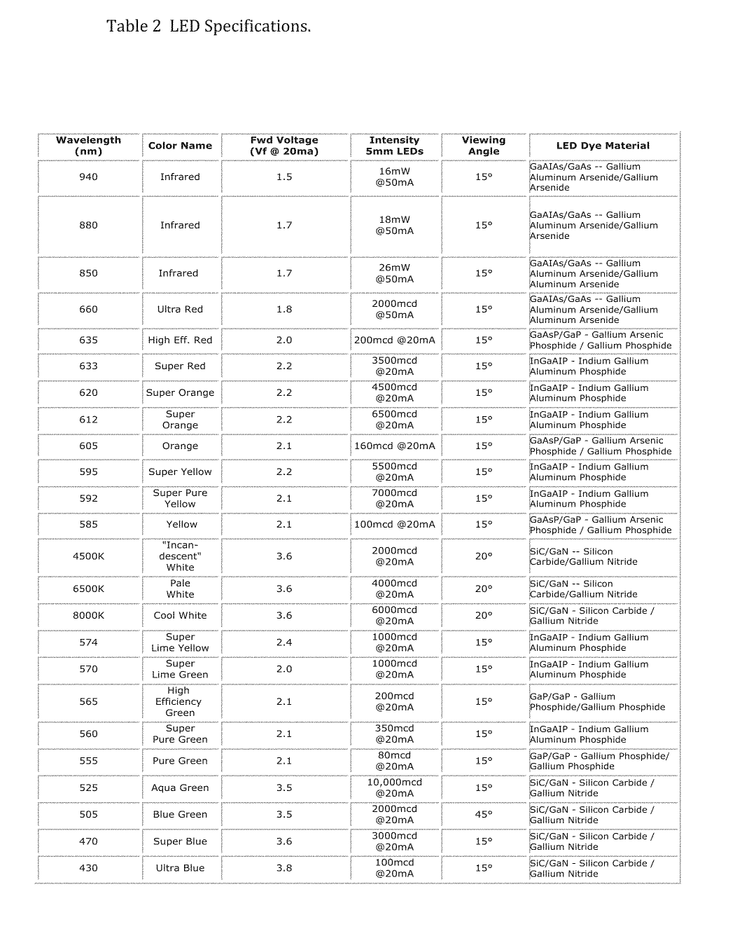

When no current flows from any PNP transistor 122, 119, 116, 113 collector the resistor 112 keeps the base of NPN transistor 111 at zero volts and NPN transistor 111 may therein be switched off. By making the resistance value of resistor 134 small compared to the resistance value of resistor 112, when current flows from any PNP transistor 122, 119, 116, 113 collector the voltage drop across resistor 112 will rise rapidly and turn on NPN transistor 111 activating audible device 110. In this manner any excessive current drawn from output tabs 128-131 may produce an audible warning tone. The audible device 110, 712 may be replaced with a visual device such as a red light or both audible and visual warning indicators could be used simultaneously as shown in FIG. 7.

FIG. 2 illustrates a battery housing 127 with a zero volt output tab 132 and four different voltage output tabs 128-131. It should be noted, that the system may work with any voltage batteries; however, if the utilized batteries 101-104 have a 1.5 volt value, similar to alkaline batteries, then the voltage between tabs 132 and 131 would be 1.5 volts, the voltage between tabs 132 and 130 would be 3 volts, the voltage between tabs 132 and 129 would be 4.5 volts, and the voltage between tabs 132 and 128 would be 6 volts. If the batteries 101-104 have a 3 volt value, similar to lithium batteries, then the voltage between tabs 132 and 131 would be 3 volts, the voltage between tabs 132 and 130 would be 6 volts, the voltage between tabs 132 and 129 would be 9 volts, and the voltage between tabs 132 and 128 would be 12 volts. In either case the current drawn from any tab is protected with a fusible circuit and a warning indicator.

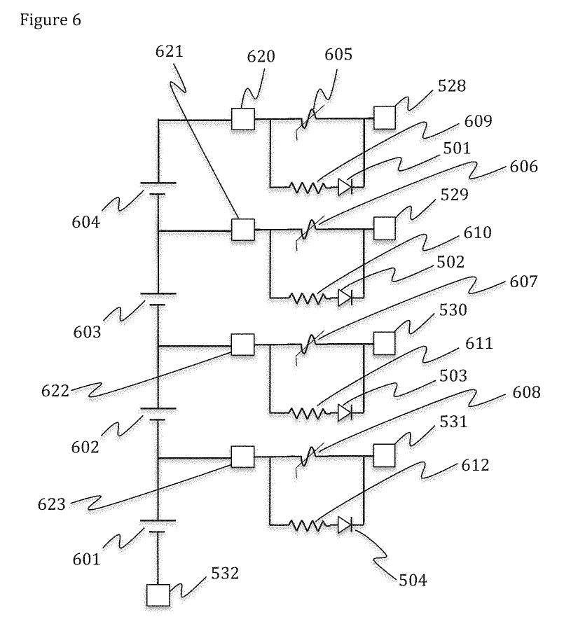

FIG. 4 illustrates how different battery holders 401-403 may be wired to increase the voltage level and still have over current protection with a warning indicator. Connecting wire 410 to zero voltage tab 404 of battery case 401, connecting a wire 411 between battery tab 405 of battery holder 401 and battery tab 406 of battery holder 402, connecting a wire 412 between battery tab 407 of battery holder 402 and battery tab 408 of battery holder 403, produces a voltage difference of 15 volts at a wire 413 connected to battery tab 409 and wire 410 if 1.5 volt batteries are used. This voltage difference would double to 30 volts if 3 volt batteries were being used. Still, in either case any excessive current drawn from any battery 401-403 output tab 405-409 would be protected and activate a warning indicator 110, 712.

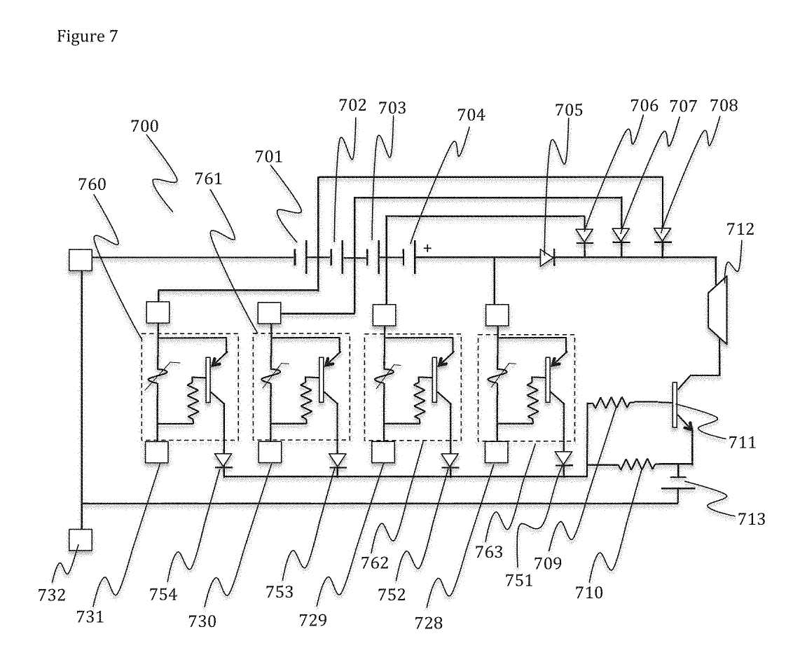

Table 1 is provided to show data from a battery holder 527 shown in FIG. 5 with internal electronic circuit 700 shown in FIG. 7, that contained new 1.5 volt alkaline batteries 701-704, 713 and had output pins 728-731 shorted to zero volt pin 732 to produce excessive current. The actual output current after 10 seconds was measured and recorded for each short. In every short with all batteries installed both sound 712 and a light indicator 751-754 were activated.

Another instance of a battery holder 527 designed solely for cells with a 3 volt output, such as lithium batteries, is shown in FIG. 5. Table 2 shows that a LED, light emitting diode, needs at least 1.8 volts to produce visible light. If LEDs 501-504 are placed directly across the PTC fuses 605-608 the 3 volt cells will produce a large enough voltage across the PTC fuse 605-608 when activated to turn on an LED 501-504 and indicate an overcurrent condition with only one other electronic component, a resistor 609-612, required to build a fusible circuit.

Still another instance of a battery holder 527 that uses internal circuit shown in electronic schematic 700 in FIG. 7, produces both audible and visual indications of an excessive current condition, lowers the current, and works with any batteries 701-704 with a cell voltage greater than 1 volt. Fusible circuit blocks 760-763 shown in FIG. 7, function identical to the fusible circuit blocks 150-153 shown in FIG. 3. The addition of a LED 751-754 in series with the collector of each transistor 113, 116, 119, 122 forces current to turn on the LED 751-754 associated with the output tab 728-731 that is being protected from excessive current. These visual LED 751-754 indicators can be physically located near the output tab they are associated with as shown in FIG. 5, 501-504. Because the battery 701-704 voltages may be close to 1 volt, an extra battery 713 needs to be added to make the voltage drop across the series LED 751-754 great enough to turn on. The extra battery 713 can be viewed as a negative supply voltage for the fusible circuits.

The resistor 710 needs to be valued low enough to allow sufficient current to flow to the negative supply 713 to light the LED 751-754 and high enough to produce a voltage drop that will turn on the NPN transistor 711 and activate the audio device 712. A value of 500 ohms was used for resistor 710 in the test circuit for data taken in Table 1. The resistor 709 must be low enough to allow sufficient base current into the NPN transistor 711 and high enough to limit current to the negative source 713. A value of 1000 ohms was used for resistor 709 in the test circuit for data taken in Table 1. If battery 704 is removed from the holder, output 728 will drop to zero volts and basically be an open circuit with no affect if shorted to any other output 729-732. All other outputs 729-731 will perform normally with power for the audio device 712 supplied through diode 706 from battery 703.

Audio level from audio device 712 will drop slightly due to lower voltage source. If batteries 704 and 703 are removed from the holder, outputs 728 and 729 will drop to zero volts and basically be open circuits with no affect if shorted to any other output 730-732. All other outputs 730-731 will perform normally with power for the audio device 712 supplied through diode 707 from battery 702. Audio level from audio device 712 will drop again due to lower voltage source. If batteries 704, 703, and 702 are removed from the holder, outputs 728, 729, and 730 will drop to zero volts and basically be open circuits with no affect if shorted to the last output 731 or ground 732. The remaining output 731 will perform normally with power for the audio device 712 supplied through diode 708 from battery 701. Audio level from audio device 712 will be weak due to low voltage source.

Although the inventions described by reference to this preferred embodiment could be modified by using circuits to generate a negative supply or modify other fusible circuits, it is not intended that the novel assembly be limited thereby, but that modifications thereof are intended to be included as falling within the broad scope and spirit of the foregoing disclosure, and the appended drawings.

We claim:

1) A multiple voltage output battery housing comprising:
a housing have a top, a bottom, a front, a back, a first side, a second side and a generally hollow interior;
wherein the interior of the housing is capable of temporarily receiving a plurality of batteries;
a circuit board electronically connected to the batteries wherein the circuit board is located within the interior of the housing;
a plurality of positive temperature coefficient fuses electrically connected to the circuit board and wherein the positive temperature coefficient fuses are located within the interior of the housing;
a first conductive battery tab electrically connected to the circuit board wherein the first conductive battery tab is capable of forming an electrical contact with the battery;
a second conductive battery tab electrically connected to the circuit board wherein the second conductive battery tab is capable of forming an electrical contact with the battery and wherein the first conductive battery tab is located at the opposite polar end of the battery as the second conductive battery tab; and
a first conductive output tab electrically connected to the circuit board wherein the first conductive output tab is capable of allowing a voltage of the first conductive battery tab to be accessed outside of the battery housing by an electrical component located outside of the housing;
a second conductive output tab electrically connected to the circuit board wherein the second conductive output tab is capable of allowing the voltage of the second conductive battery tab to be accessed outside of the battery housing by an electrical component located outside of the housing;
wherein each battery located within the interior of the housing has an independent positive temperature coefficient fuse connected between the second electrical conductive battery tab and the second conductive output tab;

2) The multiple voltage output battery housing of claim 1 wherein the positive temperature coefficient fuses are automatically resettable.

3) The multiple voltage output battery housing of claim 1 further comprising:
an opening on an exterior of the housing wherein the opening extends into the generally hollow interior of the housing.

4) The multiple voltage output battery housing of claim 3 further comprising:
an audible alarm electrically connected to the circuit board wherein the audible alarm is activated upon any positive temperature coefficient fuse being activated and wherein the audible alarm produces sound through the opening of the housing.

5) The multiple voltage output battery housing of claim 1 wherein the circuit board has copper electrical paths.

6) The multiple voltage output battery housing of claim 1 further comprising:
a zero volt output tab or ground run tab electrically connected to the first conductive battery tab of the first battery with no positive temperature coefficient in series to limit the return current to the battery.

7) The multiple voltage output battery housing of claim 1 wherein the first conductive battery tab of a first battery has a first side and a second side and wherein the first side of the first conductive battery tab is in electrical contact with a negative pole of a first battery and wherein the second side of the first conductive battery tab is in electrical contact with a positive pole of a second battery.

8) The multiple voltage output battery housing of claim 1 wherein the second conductive battery tab has a first side and a second side and wherein the first side of the second conductive battery tab is in electrical contact with a positive pole of a first battery and wherein the second side of the second conductive battery tab is in electrical contact with the negative pole of a second battery.

9) The multiple voltage output battery housing of claim 1 wherein each battery in a plurality of batteries located within the interior of the housing has a positive temperature coefficient fuse in series with a second conductive output tab such that any current drawn from the second conductive output tab which exceeds a predetermined trigger threshold for the positive temperature coefficient fuse will increase the resistance of the corresponding positive temperature coefficient fuse, dropping the voltage present at the corresponding second conductive output tab and therein limiting the current from the corresponding second conductive output tab.

10) A multiple voltage output battery housing comprising:
a housing have a top, a bottom, a front, a back, a first side, a second side and a generally hollow interior;
wherein the interior of the housing is capable of temporarily receiving a plurality of batteries;
a circuit board electronically connected to the batteries wherein the circuit board is located within the interior of the housing;
a plurality of positive temperature coefficient fuses electrically connected to the circuit board wherein the positive temperature coefficient fuses are located within the interior of the housing;
a first conductive battery tab electrically connected to the circuit board wherein the first conductive battery tab is capable of forming an electrical contact with the battery;
a second conductive battery tab electrically connected to the circuit board wherein the second conductive battery tab is capable of forming an electrical contact with the battery and wherein the first conductive battery tab is located at the opposite polar end of the battery as the second conductive battery tab;
a first conductive output tab electrically connected to the circuit board wherein the first conductive output tab is capable of allowing a voltage of the first conductive battery tab to be accessed outside of the battery housing by an electrical component located outside of the housing;
a second conductive output tab electrically connected to the circuit board wherein the second conductive output tab is capable of allowing the voltage of the second conductive battery tab to be accessed outside of the battery housing by an electrical component located outside of the housing; and
a PNP transistor electrically connected to the second conductive battery tab.

11) The multiple voltage output battery housing of claim 10 further comprising:
a resistor electrically connected to the PNP transistor.

12) The multiple voltage output battery housing of claim 10 wherein the PNP transistor further comprises:
an emitter, a collector, and a base and wherein the emitter of the PNP transistor is electrically connected to a junction of a first side of one of the positive temperature coefficient fuses and the second conductive battery tab and wherein the base of the PNP transistor is electrically connected to one end of a resistor whose opposite end is connected to a junction of the second side of the positive temperature coefficient fuse and the second conductive output tab.

13) The multiple voltage output battery housing of claim 12 wherein the base and the emitter of the PNP transistor are in parallel combination with at least one of the positive temperature coefficient fuses.

14) The multiple voltage output battery housing of claim 12 wherein the PNP transistor's collector is electrically connected to a circuit that produces sound if the PNP transistor is switched on.

15) The multiple voltage output battery housing of claim 12 wherein the PNP transistor's collector is electrically connected to a circuit that produces light if the PNP transistor is switched on.

16) A multiple voltage output battery housing with outputs separated by at least three volts comprising:
a housing have a top, a bottom, a front, a back, a first side, a second side and a generally hollow interior;
wherein the interior of the housing is capable of temporarily receiving a plurality of batteries;
a circuit board electronically connected to the batteries wherein the circuit board is located within the interior of the housing;
a plurality of positive temperature coefficient fuses electrically connected to the circuit board and wherein the positive temperature coefficient fuses are located within the interior of the housing;
a first conductive battery tab electrically connected to the circuit board wherein the first conductive battery tab is capable of forming an electrical contact with the battery;
a second conductive battery tab electrically connected to the circuit board wherein the second conductive battery tab is capable of forming an electrical contact with the three volt source and wherein the first conductive battery tab is located at the opposite polar end of the three volt source as the second conductive battery tab;
a first conductive output tab electrically connected to the circuit board wherein the first conductive output tab is capable of allowing a voltage of the first conductive battery tab to be accessed outside of the battery housing by an electrical component located outside of the housing;
a second conductive output tab electrically connected to the circuit board wherein the second conductive output tab is capable of allowing the voltage of the second conductive battery tab to be accessed outside of the battery housing by an electrical component located outside of the housing;
a resistor in series with an LED that will produce light if more than a preset voltage limit is placed across the series combination;
wherein the positive temperature coefficient fuse is electrically connected between the second electrical conductive battery tab and the second conductive output tab; and
the resistor in series with an LED is placed in parallel with the positive temperature coefficient fuse and will turn on if more than two volts appears across the fuse.

17) The multiple voltage output battery housing of claim 16 wherein the LED flashes when it is activated.

18) The multiple voltage output battery housing of claim 16 further comprising:
an anode of a diode wherein the anode of the diode is electronically connected to one of the positive battery tabs and a cathode of the diode and wherein both are connected to the sound alarm circuit in order to produce a warning sound even when some batteries are not installed.

19) The multiple voltage output battery housing of claim 16 further comprising:
a long-life battery electronically connected to the alarm wherein the life-long battery is not activated in normal operation but allows activation of the alarm even when all other batteries which supply current to the output tabs have been discharged and are very low in voltage.
